(19) United States
(12) Patent Application Publication
(10) Pub. No.: US 2003/0040562 A1
(43) Pub. Date: Feb. 27, 2003

(54) A METHOD OF FILLING AND SEALING WOOD

(76) Inventors: William Osborne West, Oneida, TN (US); Burton Wilson, Pine Knot, KY (US)

Correspondence Address: Adams, Schwartz & Evans, P.A., 2180 Two Wachovia Center, Charlotte, NC, 28282, US

(21) Appl. No.: 10/252,793

(22) Filed: Sep. 23, 2002

Related U.S. Application Data
(62) Division of application No. 09/488,266, filed on Jan. 20, 2000, now abandoned.

(51) Int. Cl. C08K 5/06; C08K 3/20; C08J 3/02

(52) U.S. Cl. 524/377; 524/507

(57) ABSTRACT

A wood sealer composition for preparing wood for subsequent finishing steps, comprising a water-based acrylic polymer emulsion and a water-based urethane resin solution, wherein the acrylic polymer emulsion comprises at least 50 percent by weight of the total composition and at least three times the percentage by weight of the urethane resin solution.

### TECHNICAL FIELD AND BACKGROUND OF THE INVENTION

This invention relates to a wood filling and sealing composition and method. The invention has application in the preparation of many wood products for subsequent finishing operations. The particular composition disclosed herein is intended for application to hardwood flooring products such as strips and blocks made from hardwoods such as oak and maple. The composition is principally water-based, and therefore presents reduced emission of volatiles.

However, water-based sealing compositions also present problems when used in manufacturing operations. Water raises the grain of wood to which it is exposed, requiring additional sanding steps before additional finishing steps can be carried out. Prior efforts by applicant were focused on improving waterborne fillers as a separate product. Applicant did develop a waterborne, colored filler which adequately filled and colored the pores and grain of the wood and provided a smooth, sealed surface for further processing steps. This product was only a filler/sealer, and even though it resulted in an acceptable product, it was difficult to apply. It became very heavy-bodied on the filler roll coater and was not well accepted by the operators.

A different approach was attempted using conventional wood sealer being used in the finishing operation. The wood sealer was modified to become a filler/presealer, and included both urethane and acrylic polymers, with the urethane component predominating. Generally, the composition included approximately 65-72 percent water-based urethane and 25 percent water-based acrylic polymer. Since the composition was mainly urethane, it had a low concentration of cosolvent, but the cosolvent needed was a slow-drying solvent.

Color was added and the viscosity increased. It was applied and sanded in a similar manner to the original filler. Application was straightforward. It initially raised the grain of the wood, filled the pores and left a light film on the surface which was sanded off during a subsequent sanding operation. Additional waterborne coatings did not raise the grain again.

The flooring product had a very well defined dark grain because of the color in the composition which enhanced its appearance. Some production difficulties remained. Sanding was difficult because of the thermoplastic nature of the predominant urethane component. Heat generated during the sanding process melted some of the urethane causing the sandpaper to become quickly loaded with urethane particles. Viscosity of the composition increased rapidly during the operation, causing operator difficulties. Finally, the product was very expensive due to the predominance of the expensive urethane component. This is particularly wasteful since most of the composition is removed during the sanding operation.

The present invention is a further, significant improvement over prior compositions. The percentage of urethane has been substantially reduced and the percentage of acrylic substantially increased, with unexpected improvements in application, sanding and cost.

### SUMMARY OF THE INVENTION

Therefore, it is an object of the invention to provide a wood sealing composition which is relatively inexpensive.

It is another object of the invention to provide a wood filling and sealing composition which is easily sanded, substantially-reducing loading of the sandpaper with polymer particles.

It is another object of the invention to provide a wood filling and sealing composition which dries more quickly.

It is another object of the invention to provide a wood filling and sealing composition which has a stable viscosity.

It is another object of the invention to provide a method of filling and sealing composition which utilizes the composition according to the invention.

These and other objects of the present invention are achieved in the preferred embodiments disclosed below by providing a wood sealer composition for preparing wood for subsequent finishing steps, comprising a water-based acrylic polymer emulsion and a water-based urethane resin solution, wherein the acrylic polymer emulsion comprises at least 50 percent by weight of the total composition and at least three times the percentage by weight of the urethane resin solution.

According to one preferred embodiment of the invention, the acrylic polymer emulsion comprises at least 50 by weight of water.

According to another preferred embodiment of the invention, the urethane resin solution comprises at least 50 by weight of water.

According to yet another preferred embodiment of the invention, the urethane resin solution comprises pyrrolidinone, 1-methyl and triethylamine, wherein the pyrrolidinone, 1-methyl is present in a percentage by weight approximately four times the percentage by weight of triethylamine.

According to yet another preferred embodiment of the invention, a wood sealer composition is provided for preparing wood for subsequent finishing steps, comprising a water-based acrylic polymer emulsion and a water-based urethane resin solution, wherein the acrylic polymer emulsion comprises approximately 67 percent by weight of the total composition and at least four times the percentage by weight of the urethane resin solution.

According to yet another preferred embodiment of the invention, the wood filling and sealing composition includes a wood stain.

According to yet another preferred embodiment of the invention, the wood filling and sealing composition includes a cosolvent premix.

According to yet another preferred embodiment of the invention, the wood filling and sealing composition includes a thickener.

According to yet another preferred embodiment of the invention, the wood filling and sealing composition includes a surfactant.

According to yet another preferred embodiment of the invention, the wood filling and sealing composition includes a glycol ether solvent.

According to yet another preferred embodiment of the invention, a water-based acrylic polymer emulsion includes approximately 67 percent by weight of the total composition, a urethane resin solution approximately 15 percent by weight of the total composition, a hardening agent, a solvent, a thickener and water.

According to yet another preferred embodiment of the invention, the hardening agent comprises triethylamine in an amount of less than 1 percent by weight of the total composition.

According to yet another preferred embodiment of the invention, the thickener comprises a polyacrylic acid.

According to yet another preferred embodiment of the invention, includes a wood stain.

An embodiment of the method according to the invention comprises the steps of coating the wood product with a wood sealer composition according to the invention disclosed herein, drying the wood sealer composition coating on the wood product, sanding the wood product, and applying a surface finish to the wood product.

According to yet another preferred embodiment of the invention, the wood product comprises hardwood flooring elements.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic flow diagram of a preferred embodiment of the method according to the invention.

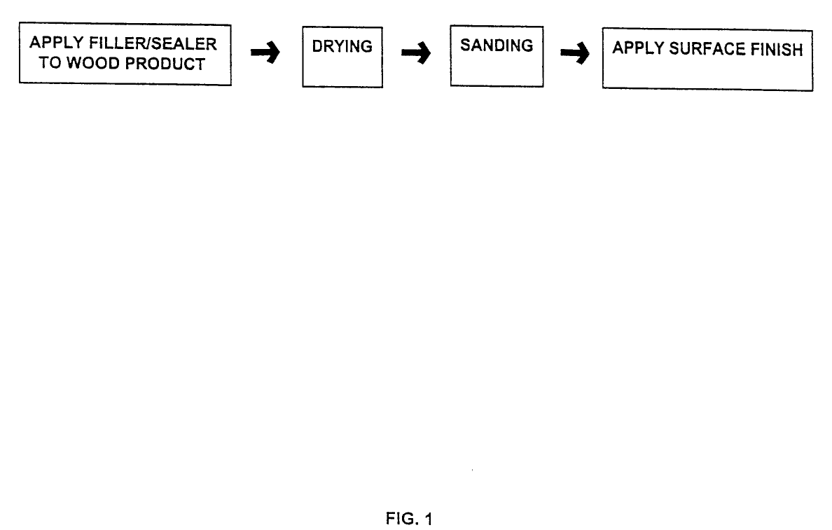

### DESCRIPTION OF THE PREFERRED EMBODIMENT AND BEST MODE

Examples of the wood filling and seal composition are set out below:

### EXAMPLE NO. 1

| Component | % by weight | Range |
|---|---|---|
| Water-based acrylic polymer emulsion | 66.9 | 50-70 |
| (Carboset CR716) | | |
| Water | 7.1 | 7-10 |
| NXZ (defoamer) | 0.25 | |
| Hardener, curing agent and pH adjuster | 0.1 | |
| Triethylamine (TEA) | | |
| Glycol Ether PM | 5 | |
| Glycol Ether EB | 5 | |
| (Cosolvents) | | |
| Water-based urethane solution | 15 | 10-20 |
| (Sancure 815) | | |
| Surfactant (Triton GR 5M) | 0.25 | |
| Polyacrylic acid thickener | 0.4 (est.) | |
| (Acrysol RM-8W) | | |
| Pigment | 0.2 (approx) | |

### Notes

Carboset CR716 is an acrylic copolymer emulsion manufactured and sold by B F Goodrich Specialty Chemicals having total solids by weight of 42 percent, a density of pounds per gallon, a Brookfield viscosity-RVT (25 C. # 3 spindle, cps of 40 and a pH of 7.2-8. Minor components are adjusted based on results of empirical testing.

Triethylamine is a catalytic solvent which acts as a curing and hardening agents for polymers.

Glycol Ethers are a category of cosolvents. The two particular ones used have relatively rapid drying rates.

Sancure 815 is a urethane resin solution manufactured and sold by BF Goodrich Specialty Chemicals and comprised of 8.52 percent by weight of pyrrolidinone, 1-methyl and 2.05 percent by weight of triethylamine, with 68.9 percent volatiles.

Triton GR 5M is a conventional surfactant and substantially reduces the surface tension of the composition, thereby reducing foaming and improving application characteristics.

Acrysol RM-8W is a polyacrylic acid thickener which stabilizes the viscosity of the composition.

### Mixing Procedure

The composition is prepared by placing the Carboset CR716 in a mixer and 2 percent water is added under light mixing.

The triethylamine and 1.1 water is mixed and one-half is added to the CR716/water mixture to form a polymer blend.

The pigments are conventional pigments used in waterborne stains, and typically include Burnt Umber 5509, Red 5625, Yellow 5454 and Black 5317.

In a separate vessel the glycol ether PM cosolvent, glycol ether EB cosolvent and 4 percent water is mixed to form a cosolvent premix.

The cosolvent premix is then added to the polymer blend while slowly mixing the polymer blend. Adding the cosolvent premix too rapidly will cause flashout of the polymer.

The Sancure 815 urethane resin and Triton GR 5M surfactant is added to the mix.

If stains are to be added, they are then added to the mix and thoroughly and evenly incorporated into the mix.

Finally, the Acrysol RM-8W thickener is added to achieve a 18-22 second viscosity using #5 Zahn. The specified amount is an estimate. The exact amount added is determined empirically.

In general, the novel filling and sealing composition uses a relatively high concentration of acrylic and a relatively low concentration of urethane. The Carboset CR716 is used because of the small particle size and its high film formation temperature. By using triethylamine instead of ammonia for pH adjustments, greater penetration of the composition into the wood is obtained. The Sancure 815 was retained from prior art compositions due to its excellent film formation and sealing qualities, but with a dramatically lower concentration.

The acrylic component can range from approximately 65 to 70 percent. The urethane component is relatively stable at approximately 15 percent. In order for this system to work properly, it was determined that two separate cosolvents are used, both of which have relatively rapid drying rates.

Three distinct and surprising advantages are achieved using this composition.

First, the high acrylic concentration permits easier sanding, forming a fine powder instead of a rubbery film during sanding. As noted above, substantial savings in sandpaper are achieved due to significantly less loading of the sandpaper.

Second, the entire system dries more quickly and evenly.

Third, the composition penetrates further into the wood. This permits continued protection of the wood surface when the water-based stain is later applied to the sealed wood. In some instances one of the sanding steps may be hitting the wood too hard and thus removing too much surface. Prior art sealers remained mainly on the surface of the wood. Thus, if too much of the surface was removed, almost all of the sealer was removed, causing the grain in those areas to raise again when the water-based stain was applied. Because of the increased penetration, significantly less pigment, up to 60 percent less, is required to properly color the filled areas of the wood surface, further reducing costs and reducing drying time.

The method according to the invention includes application of the filler/sealer to wood products such as solid and laminated hardwood flooring strips, planks and blocks at an application rate of approximately 6-8 grams per square foot. Application is by means of a rubber-covered application roller.

The coated wood products are dried by a combination of infrared and convection heat, as conventionally practiced.

The dried wood products are conventionally sanded in a multi-stage sanding operation using progressively finer grades of sandpaper. After the surface of the sanded wood product is carefully cleaned of all dust and loose wood fibers, final finishing steps are carried out, including application of a stain and application of multiple coats of a water-based urethane top finish, which may be dried by application of infrared and convection heat or cured by ultraviolet (UV) light, respectively.

A wood filling and sealing composition and a method of filling and sealing a the surface of a wood product are described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A wood sealer composition for preparing wood for subsequent finishing steps, comprising a water-based acrylic copolymer emulsion and a water-based urethane resin solution, wherein the acrylic copolymer emulsion comprises at least 50 percent by weight of the total composition and at least three times the percentage by weight of the urethane resin solution.

2. A wood sealer composition according to claim 1, wherein at least 50 by weight of the acrylic copolymer emulsion comprises water.

3. A wood sealer composition according to claim 1, wherein at least 50 percent by weight of said urethane resin solution comprises water.

4. A wood sealer composition according to claim 1, wherein said urethane resin solution comprises pyrrolidinone, 1-methyl and triethylamine, wherein the pyrrolidinone, 1-methyl is present in a percentage by weight approximately four times the percentage by weight of triethylamine.

5. A wood sealer composition for preparing wood for subsequent finishing steps, comprising an water-based acrylic copolymer emulsion and a water-based urethane resin solution, wherein the acrylic copolymer emulsion comprises approximately 67 percent by weight of the total composition and at least four times the percentage by weight of the urethane resin solution.

6. A wood sealer composition according to claim 1 or 5, and including a wood stain.

7. A wood sealer composition according to claim 1 or 5, and including a cosolvent premix.

8. A wood sealer composition according to claim 1 or 5, and including a thickener.

9. A wood sealer composition according to claim 1 or 5, and including a surfactant.

10. A wood sealer composition according to claim 1 or 5, and including a glycol ether solvent.

11. A wood sealer composition for preparing wood for subsequent finishing steps, comprising:
(a) a water-based acrylic copolymer emulsion approximately 67 percent by weight of the total composition;
(b) urethane resin solution approximately 15 percent by weight of the total composition;
(c) a hardening agent;
(d) a solvent;
(e) a thickener; and
(f) water.

12. A wood sealer composition according to claim 11, wherein said hardening agent comprises triethylamine in an amount of less than 1 percent by weight of the total composition.

13. A wood sealer composition according to claim 11, wherein said thickener comprises a polyacrylic acid.

14. A wood sealer composition according to claim 11, and including a wood stain.

15. A method of preparing a wood product for subsequent finishing steps, comprising the steps of:
(a) coating the wood product with a wood sealer composition according to claim 1, 2, 3, 4, 5, 11, 12, 13 or 14;
(b) drying the wood sealer composition coating on the wood product;
(c) sanding the wood product; and
(d) applying a surface finish to the wood product.

16. A method according to claim 15, wherein the wood product comprises hardwood flooring elements.

17. A wood sealer composition for preparing wood for subsequent finishing steps, consisting essentially of a water-based acrylic copolymer emulsion and a water-based urethane resin solution, wherein the acrylic copolymer emulsion comprises at least 50 percent by weight of the total composition and at least three times the percentage by weight of the urethane resin solution.

18. A wood sealer composition according to claim 17, wherein at least 50 percent by weight of the acrylic copolymer emulsion comprises water.

19. A wood sealer composition according to claim 17, wherein at least 50 percent by weight of said urethane resin solution comprises water.

20. A wood sealer composition according to claim 17, wherein said urethane resin solution comprises pyrrolidinone, 1-methyl and triethylamine, wherein the pyrrolidinone, 1-methyl is present in a percentage by weight approximately four times the percentage by weight of triethylamine.

21. A wood sealer composition for preparing wood for subsequent finishing steps, consisting essentially of a water-based acrylic copolymer emulsion and a water-based urethane resin solution, wherein the acrylic copolymer emulsion comprises approximately 67 percent by weight of the total composition and at least four times the percentage by weight of the urethane resin solution.

22. A wood sealer composition according to claim 17 or 21, and including a wood stain.

23. A wood sealer composition according to claim 17 or 21, and including a cosolvent premix.

24. A wood sealer composition according to claim 17 or 21, and including a thickener.

25. A wood sealer composition according to claim 17 or 21, and including a surfactant.

26. A wood sealer composition according to claim 17 or 21, and including a glycol ether solvent.

27. A wood sealer composition for preparing wood for subsequent finishing steps, consisting essentially of:
(a) a water-based acrylic copolymer emulsion approximately 67 percent by weight of the total composition;
(b) a urethane resin solution approximately 15 percent by weight of the total composition;
(c) a hardening agent;
(d) a solvent;
(e) a thickener; and
(f) water.

28. A wood sealer composition according to claim 27, wherein said hardening agent comprises triethylamine in an amount of less than 1 percent by weight of the total composition.

29. A wood sealer composition according to claim 27, wherein said thickener comprises a polyacrylic acid.

30. A wood sealer composition according to claim 27, and including a wood stain.
